(19) United States
(12) Patent Application Publication
(10) Pub. No.: US 2008/0217041 A1
(43) Pub. Date: Sep. 11, 2008

(54) Grounding Wire Structure Having Stainless Steel Covering and Method of Manufacturing the Same

(76) Inventor: Kui-Yeun Kim, Seoul (KR)

Correspondence Address: LEVINE & MANDELBAUM, 444 MADISON AVENUE, 35TH FLOOR, NEW YORK, NY, 10022, US

(21) Appl. No.: 12/088,468

(22) PCT Filed: Oct. 27, 2005
(86) PCT No.: PCT/KR05/03589

§ 371 Date: Mar. 28, 2008

(30) Foreign Application Priority Data
Oct. 25, 2005 (KR) 10-2005-0100847

(51) Int. Cl. H01R 4/66; H01R 43/00

(52) U.S. Cl. 174/6; 29/825

(57) ABSTRACT

The present invention provides a grounding wire structure having a stainless steel covering and a method of manufacturing the grounding wire structure. In the present invention, first and second hollow connection frames (4) and (4′), each of which has a compressing groove (4a), (4a′) and an internal thread (4b), (4b′), are coupled to respective opposite ends of a stainless steel pipe (1), in which a grounding wire (2) is provided, and which is filled with graphite (3). Corrugated grooves are formed in the outer surface of the stainless steel pipe (1). A connection socket (5) is coupled to the internal thread (4b) of the first connection frame (4). A connection rod (6) is coupled to the internal thread (4b′) of the second connection frame (4′). Discharge tip assemblies (A), each of which has discharge tip bodies (7) and (7′) connected to each other through a connection pin (8), are fitted over the corrugated grooves of the stainless steel covering pipe (1).

### TECHNICAL FIELD

The present invention relates to a grounding wire structure, which has a stainless steel covering and is used to prevent lightning damage, and a method of manufacturing the grounding wire structure.

### BACKGROUND ART

In the conventional art, grounding wire is laid to a length ranging from 20 m to 40 m, and to prevent corrosion, concrete including grounding resistance reducing material is applied to the grounding wire to a thickness of 10 cm and a width of 40 cm to protect the grounding wire and to increase the discharge area. Furthermore, concrete is applied to the grounding wire to increase the discharge area. In a region where discharge is difficult depending on geographical conditions, for example, in a region where there are many rocks or a lot of gravel, a separate needle-shaped stainless steel grounding rod for additional grounding is provided to govern spark discharge.

However, in the conventional art, because concrete mixed with resistance reducing material is applied to the grounding wire, the natural environment is deteriorated, and construction costs are increased, and thus it is very uneconomical. Furthermore, there is a problem in that cracking occurs in the concrete structure due to thermal shock by resistance heat or due to freezing in winter, and thus the grounding wire, installed in the concrete structure, corrodes.

In an effort to overcome the above-mentioned problems, a grounding wire covered with a stainless steel corrugated pipe was developed. However, because the density at which the graphite and grounding resistance reducing material are combined with the stainless steel corrugated pipe is relatively low, and because they are not heat-treated, the stainless steel corrugated pipe is easily damaged by the expansion of the sealed interior space in the corrugated pipe due to electric resistance heat or due to freezing.

In addition, because the needle-shaped grounding rod is made of stainless steel having a relatively low melting point of 1000° C., the needle-shaped portion thereof is easily damaged by high discharge heat due to spark discharge. As such, there is a problem in that maintenance is very difficult.

Meanwhile, a discharge tip, which has relatively high durability in order to mitigate the above problem, has been developed. However, because a carbon discharge tip or a carbon concrete portion and a nonconductor concrete portion are not enamelized, it has no waterproofing function. Thus, there is a problem in that, due to the penetration of moisture, it may burst due to heat expansion or freeze and thus burst.

### DISCLOSURE OF INVENTION

### Technical Problem

Accordingly, the present invention has been made keeping in mind the above problems occurring in the prior art, and an object of the present invention is to provide a grounding wire structure having a stainless steel covering which includes a discharge tip having a superior waterproofing function to solve the problem of penetration of moisture, and in which discharge tip assemblies including discharge tip bodies are directly fitted to the grounding wire structure having a stainless steel covering pipe, unlike the conventional art, in which the grounding wire structure and a needle-shaped grounding rod are separately laid in the ground, so that, in a region where spark discharge is not required, the discharge tip assemblies serve to increase the discharge area of the grounding wire structure, and, in a region where current discharge is easily caused, spark discharge can be easily caused, and in which a filling substance mixed with grounding resistance reducing material is charged into the stainless steel covering pipe at high pressure, so that, in a marshy region where there is plenty of chlorine, sulfur and iron, even if the stainless steel covering pipe corrodes, the grounding resistance reducing material is solidified when moisture penetrates, thus protecting the grounding wire.

### Technical Solution

In order to accomplish the above object, the present invention provides a grounding wire structure having a stainless steel covering pipe, which is made of austenitic stainless steel that is stable even at a temperature ranging from −200° C. to 900° C. and has an outer diameter of 50 mm or less and a thickness of 0.5 mm or less, and which is filled with filling substance and is thereafter corrugated. Furthermore, the stainless steel covering pipe is disposed to an appropriate length depending on conditions and, more preferably, is disposed to a length of 2 m or less. In addition, discharge tip assemblies including discharge tip bodies, in each of which a graphite substance and an insulator are enamelized to solve the problem of penetration of moisture, are directly fitted to the grounding wire structure, unlike the conventional art, in which the grounding wire structure and a needle-shaped grounding rod are separately laid in the ground, thus providing a grounding wire structure having combined functions.

### Advantageous Effects

In the grounding wire structure according to the present invention, because a covering pipe for a grounding wire is made of stainless steel, the durability of the grounding wire structure is superior. Furthermore, the interior of the stainless steel covering pipe maintains the vacuum state without moisture, so that it is prevented from bursting due to heat expansion or from freezing and thus bursting. Because graphite, which has superior electric conductivity and a melting point of 3000° C. or more, which is sufficient to prevent thermal deformation, is used, the durability of a discharge tip is increased. As well, in addition to being environmentally friendly, the product is standardized, thus errors are prevented from occurring in the design and construction work of laying the grounding wire, thus there is an advantage in that construction costs are reduced. Even in a marshy region, the grounding wire structure of the present invention can maintain the durability thereof. As such, the present invention provides an effective and economical grounding wire structure having the stainless steel covering.

### BRIEF DESCRIPTION OF THE DRAWINGS

FIG. 1 is an exploded perspective view of a cut portion of a grounding wire structure according to the present invention;

FIG. 2 is a sectional view of the cut portion of the ground wire structure according to the present invention; and

FIG. 3 is a sectional view of a discharge tip assembly according to the present invention.

### BEST MODE FOR CARRYING OUT THE INVENTION

Hereinafter, the construction and operation of the present invention will be described in detail with reference to the attached drawings.

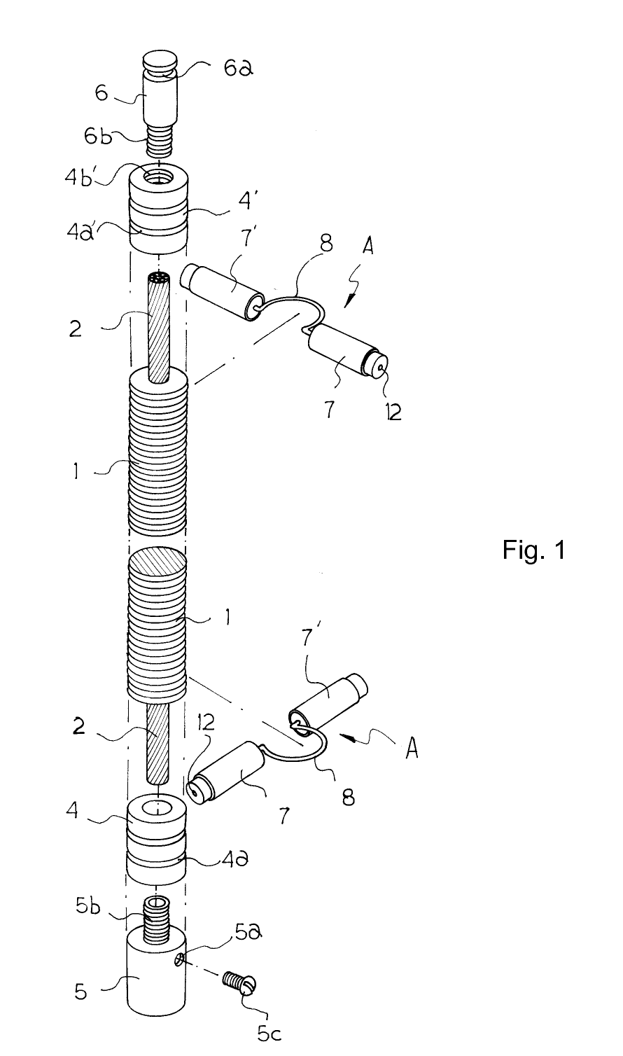

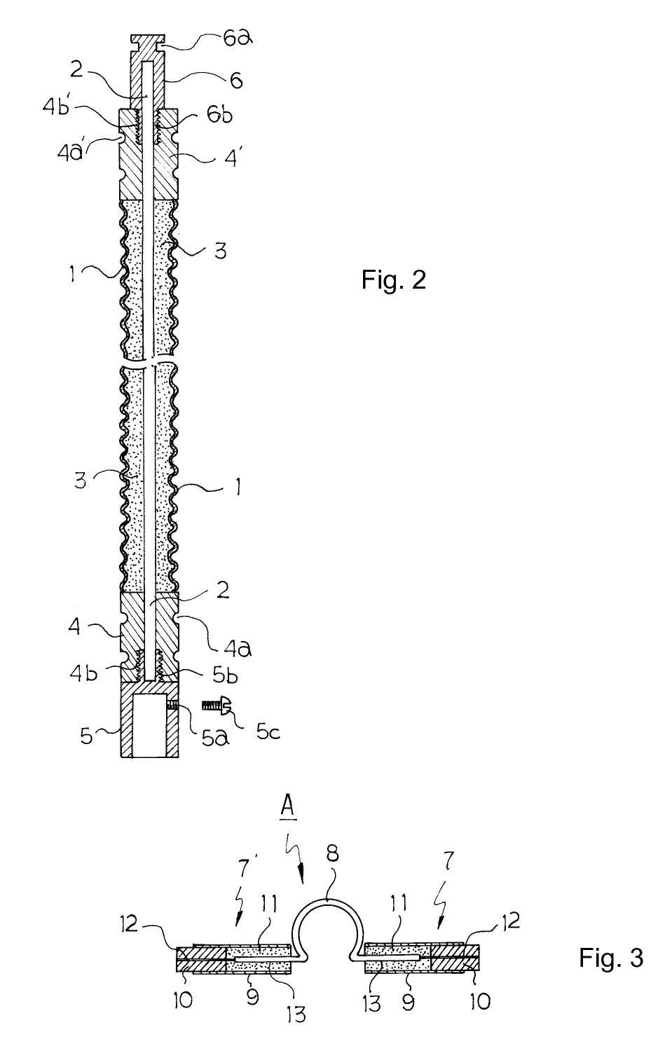

FIG. 1 is an exploded perspective view of a cut portion of a grounding wire structure according to the present invention, showing the construction in which connection frames are coupled to the upper and lower ends of a stainless steel covering pipe that covers a grounding wire, a connection socket and a connection rod are coupled to the respective connection frames, and discharge tip assemblies, in each of which discharge tip bodies are coupled by a connection pin, are fitted over the covering pipe at intervals of 5 cm. FIG. 2 is a sectional view of the cut portion of the ground wire structure according to the present invention, showing the connection frames, the connection socket and the connection rod which are coupled to the opposite ends of the covering pipe, which is filled with graphite and ground resistance reducing material, or only with graphite, and into which the ground wire is inserted. FIG. 3 is a sectional view of a discharge tip assembly according to the present invention, showing the construction of the discharge tip assembly in which discharge tip bodies, each of which has a connection pin insert hole in one end thereof and a discharge pin in the other end thereof and includes a stainless steel tube, in which a graphite body and an insulator are provided, are coupled to each other through the connection pin, the opposite ends of which are inserted into the connection pin insert holes of the respective discharge tip bodies.

In detail, the first and second hollow connection frames 4 and 4′, each of which has compressing grooves 4a, 4a′ in a circumferential outer surface thereof and has an internal thread 4b, 4b′ in a circumferential inner surface of an end thereof, are coupled to the respective opposite ends of the stainless steel pipe 1, which is filled with graphite 3, and in which the grounding wire 2 is provided such that opposite ends thereof are inserted into the respective connection frames 4 and 4′. Thereafter, the compressing grooves 4a and 4a′ of the first and second connection frames 4 and 4′ are compressed inwards so that the first and second connection frames 4 and 4′ are reliably coupled to the opposite ends of the grounding wire 2 on the opposite ends of the stainless steel pipe 1. Furthermore, corrugated grooves are formed in the circumferential outer surface of the stainless steel pipe 1. The connection socket 5, which has an external thread 5b and has at a predetermined position an air discharge hole 5a, is coupled to the lower internal thread 4b of the first connection frame 4 by a screw coupling method. A screw 5b is removably engaged in the air discharge hole 5a.

Furthermore, the connection rod 6, which has a coupling slot 6a and has an external thread 6b, is coupled to the upper internal thread 4b′ of the second connection frame 4′ by a screw coupling method. The discharge tip assemblies (A), each of which has at opposite ends thereof discharge tip bodies 7 and 7′ connected to each other through a connection pin 8, are fitted over the corrugated grooves of the circumferential outer surface of the stainless steel covering pipe 1 through openings defined in the connection pin 8.

Here, the stainless steel covering pipe 1 may be filled with graphite alone before the corrugated grooves are formed in the circumferential outer surface of the stainless steel covering pipe 1.

Each discharge tip body 7, 7′ is formed by placing an insulator 10 into a first end of a stainless steel tube 9 and by putting a graphite body 11 into a second end of the stainless steel tube 9. A discharge tip 12 is inserted into the first end of the discharge tip body 7, 7′, and a connection pin insert hole 13 is formed in the second end thereof such that the connection pin 8 can be coupled to the discharge tip bodies 7 and 7′. The discharge tip assemblies (A) are fitted over the stainless covering pipe 1 such that the discharge tip assemblies (A) are alternately oriented in crossing directions to have cross shapes, thus increasing the discharge area.

To manufacture the grounding wire structure of the present invention, the first end of the stainless steel covering pipe 1 is sealed using the first connection frame 4 and the connection socket 5. Thereafter, the grounding wire 2 is placed in the stainless steel covering pipe 1, and the graphite 3 is charged into the stainless steel covering pipe 1 at high pressure. Subsequently, the stainless steel covering pipe 1 is heat-treated at 300° C. to 400° C. to remove any moisture and air that is present. Before the heat is cooled, additional graphite is charged into the stainless steel covering pipe 1 and the second end of the stainless steel covering pipe 1 is thereafter sealed by the second connection frame 4′ and the connection rod 6, thus preventing the penetration of moisture and air. The corrugated grooves, each of which is 2mm in both width and depth, are formed in the circumferential outer surface of the stainless steel covering pipe 1. Thereafter, the discharge tip assemblies (A) are fitted over the corrugated grooves of the stainless steel covering pipe 1 at intervals of 5 cm. Each discharge tip assembly (A) is manufactured by inserting a connection pin 8, which is made of a stainless steel wire having a diameter of 2 mm, into the connection pin insert holes 13 of the discharge tip bodies 7 and 7′, each of which has an outer diameter of 10 mm and a length of 40 mm, and in each of which is manufactured, by forming, at a high temperature, the insulator 10, made of heat resistant insulating material, and the graphite body 11, made of graphite and clay, in the first and second ends, respectively, of the stainless steel tube 9 in a single process, by inserting the discharge tip 12, which is made of graphite having a melting point of 3000° C. or more and is formed at an end thereof in a needle shape and formed to have a diameter of 0.9 mm or less, into the insulator 10 such that it extends from the insulator 10 to a front end of the connection pin insert hole 13 of the graphite body 11, and by heating the discharge tip body 7, 7 at a high temperature of 1300° C. such that the discharge tip body 7, 7 is enamelized.

Meanwhile, to manufacture a grounding wire structure for use in a marshy place, the first end of the stainless steel covering pipe 1 is sealed using the first connection frame 4 and the connection socket 5, and, thereafter, the grounding wire 2 is placed in the stainless steel covering pipe 1, and the graphite 3 is charged into the stainless steel covering pipe 1 at high pressure. Subsequently, the stainless steel covering pipe 1 is heat-treated at 100° C. to 200° C. to remove any moisture and air which may be present. Before the heat is cooled, the second end of the stainless steel covering pipe 1 is thereafter sealed by the second connection frame 4′ and the connection rod 6, thus preventing the penetration of moisture and air. The corrugated grooves, each of which is 2 mm in both width and depth, are formed in the circumferential outer surface of the stainless steel covering pipe 1.

The present invention having the above-mentioned construction provides a grounding wire structure that can conduct functions both of the typical grounding wire and of a needle-shaped grounding rod, thus reducing construction costs, ensuring superior durability, and reducing costs and efforts in maintenance.

As shown in FIGS. 1 and 2, the first end of the stainless steel covering pipe 1 is sealed by the first connection frame 4 and the connection socket 5. The grounding wire 2 is placed in the stainless steel covering pipe 1, which is filled with graphite 3 and ground resistance reducing material, or only with graphite 3. Thereafter, the stainless steel covering pipe 1 is heat-treated, and additional filling material is charged thereinto and compressed. Before the temperature in the heat treatment process is reduced, the second end of the stainless steel covering pipe 1 is sealed with the second connection frame 4′ and the connection rod 6.

After the above process has been conducted, the corrugated grooves, each of which has a width of 2 mm and a depth of 2 mm, are formed in the circumferential outer surface of the stainless steel covering pipe 1. As shown in FIG. 3, the discharge tip assemblies (A) are fitted into the corrugated grooves of the stainless steel covering pipe 1 at intervals of 5 cm, thus completing the grounding wire structure that can have effects of the needle-shaped grounding rod and the typical grounding wire.

Here, because the corrugated grooves are formed in the circumferential outer surface of the stainless steel covering pipe 1 by compressing, the density of the filling substance charged therein is increased. Furthermore, because the flexibility of the stainless steel covering pipe 1 is increased, it can be conveniently installed at a construction site.

Preferably, austenitic stainless steel, which is stable at all temperatures ranging from −200° C. to 900° C., is used as the material of the stainless steel covering pipe 1. Furthermore, the stainless steel covering pipe 1 has an outer diameter of 50 mm or less and a thickness of 0.5 mm or less, and the length thereof is set to an appropriate length depending on the conditions. More preferably, the length of the stainless steel covering pipe 1 is 2 m or less.

Meanwhile, in the method of manufacturing the stainless steel covering pipe 1, the first end thereof is closed and the grounding wire 2, graphite 3 and grounding resistance reducing material are charged thereinto, and, thereafter, the stainless steel covering pipe 1 is heat-treated for a long time to remove moisture and air in the state in which it is placed upright without being closed at the second end thereof. Subsequently, before the temperature in the internal heat thereof is reduced, additional filling material is charged into the stainless steel covering pipe 1, and the second end thereof is sealed. Therefore, air or moisture is prevented from penetrating the stainless steel covering pipe 1. As well, because the stainless steel covering pipe 1 is in the semi-vacuum state without moisture, it is prevented from expansion-bursting at a high temperature or from being frozen to burst at a low temperature.

The connection frames 4 and 4′, the connection socket 5 and the connection rod 6, which are inserted into and coupled to the upper and lower ends of the stainless steel covering pipe 1, are assembled through the following methods.

Each connection frame 4, 4′ has the compressing grooves 4a, 4a′ in the circumferential outer surface thereof and has the internal thread 4b, 4b′, which is formed on an end of the circumferential inner surface thereof, so that the connection frames 4 and 4′ are coupled to the lower and upper ends of the stainless steel covering pipe 1 by compressing the two or three compressing grooves 4a and 4a′ inwards. The connection socket 5 and the connection rod 6 are respectively coupled to the lower and upper ends of the connection frames 4 and 4′. The connection socket 5 and the connection rod 6 respectively have the external threads 5b and 6b, so that the external threads 5b and 6b respectively engages with the internal threads 4b and 4b′ of the connection frames 4 and 4′.

As such, because the connection frames 4 and 4′ are firmly coupled to the opposite ends of the stainless steel covering pipe 1 by compressing the compressing grooves 4a and 4a′ inwards, the connection frames 4 and 4′ are prevented from being removed even if a tensioning force of 250 kg is applied thereto.

Furthermore, the air discharge hole 5a is formed at a predetermined position in the connection socket 5 and is openably closed by the screw 5c. In addition, the coupling slot 6a is formed in the end of the connection rod 6, so that, when a connection rod 6 of another grounding wire structure is inserted into the connection socket 5, air is discharged outside through the air discharge hole 5a, and, thereafter, the screw 5c is inserted into the air discharge hole 5a such that it is locked to the coupling slot 6a, thus preventing the connection rod 6 from being undesirably removed.

As such, the connection socket 5 and the connection rod 6 are coupled to the grounding wire structure, so that air and moisture are prevented from penetrating the grounding wire structure and, in addition, the grounding wire structure can be easily and reliably connected to a lightning induction wire or another grounding wire structure.

As shown in FIG. 3, the discharge tip assembly (A) is constructed by coupling the discharge tip bodies 7 and 7′, each of which has the discharge tip 12 and the connection pin insert hole 13, to each other using the connection pin 8.

The portion of each discharge tip body 7, 7′, in which the discharge tip 12 is disposed, is made of the insulator 10 which includes heat resistance insulating material and clay. The portion of the discharge tip body 7, 7′, in which the connection pin insert hole 13 for insertion of the connection pin 8 is formed, is made of the graphite body 11, including graphite and clay. The insulator 10 and the graphite body 11 are formed together at a high temperature, and the discharge tip 12, the end of which is formed in a needle shape, is inserted into the insulator 10. Thereafter, the discharge tip bodies 7 and 7′ are heat-treated at approximately 1300° C., thus being enamelized.

Because each discharge tip body 7, 7′ manufactured through the above-mentioned method has no moisture, it is prevented from bursting at high temperatures and from freezing to thus burst at low temperatures.

The circumferential outer surfaces of the insulator 10 and the graphite body 11, which form the internal frame of the discharge tip body 7, 7′, are surrounded by the stainless steel tube 9, thus increasing the durability of the discharge tip body 7, 7′.

Preferably, each discharge tip body 7, 7′ has a diameter of 10 mm or less and a length of approximately 40 mm. Furthermore, the discharge tip 12 is inserted in a direction from the insulator 10 towards the graphite body 11, such that the end of the discharge tip 12 is brought into contact with the graphite body 11, thus reliably ensuring the flow of current. As well, it is preferable that the thickness of the discharge tip 12 be 0.9 mm or less.

The discharge tip 12 made of graphite has a melting point of 3000° C. or more and is not deformed by heat, and thus it is prevented from being damaged by spark discharge and from being deformed by discharge heat, thus having superior durability. Furthermore, because the discharge tip 12 is protected by the insulator 10, superior durability thereof can be maintained.

The connection pin 8, which couples the discharge tip bodies 7 and 7′ to each other, is made of a stainless steel rod having a diameter of 2 mm. The connection pin 8 has a length appropriate for insertion of the opposite ends thereof into the respective connection pin insert holes 13 to sufficient depths. Furthermore, the connection pin 8 is formed in a semicircular shape, which is open in one direction, and the inner diameter of the semicircular-shaped portion of the connection pin 8 is equal to the outer diameter of the corrugated grooves of the stainless steel covering pipe 1, thus minimizing electrical resistance. The discharge tip bodies 7 and 7′ are coupled to each other using the connection pin 8, thus completing the discharge tip assembly (A).

The discharge tip assemblies (A) having the above-mentioned constructions are fitted over the corrugated grooves of the circumferential outer surface of the stainless steel covering pipe 1 at intervals of 5cm. Here, the discharge tip assemblies (A) are oriented such that they are alternately perpendicular to each other, thus having “+” shapes. Thereby, the present invention can provide a grounding wire structure which has an increased discharge area and the discharge tips 12 having a spark discharge function.

In a region where there is plenty of chlorine, sulfur and iron, which corrode stainless steel, the grounding wire 2 and the grounding resistance reducing material are charged at high density into the stainless steel covering pipe 1.

Furthermore, in a humid region, because electric discharge is easily caused, the present invention need not be provided with a discharge tip 12.

Although the preferred embodiment of the present invention has been disclosed for illustrative purposes, those skilled in the art will appreciate that various modifications, additions and substitutions are possible, without departing from the scope and spirit of the invention as disclosed in the accompanying claims. Therefore, such modifications, additions and substitutions must be regarded as falling within the bounds of the accompanying claims.

1. A grounding wire structure having a stainless steel covering, wherein first and second hollow connection frames (4) and (4′), each of which has a compressing groove (4a), (4a′) in a circumferential outer surface thereof and has an internal thread (4b), (4b′) on a circumferential inner surface of an end thereof, are coupled, by compressing the compressing grooves (4a) and (4a′) of the first and second connection frames (4) and (4′), to respective opposite ends of a stainless steel pipe (1), in which a grounding wire (2) is provided such that the opposite ends thereof are inserted into the respective first and second connection frames (4) and (4′), and which is filled with graphite (3), corrugated grooves are formed in a circumferential outer surface of the stainless steel pipe (1), a connection socket (5), which has an external thread (5b) and has at a predetermined position an air discharge hole (5a), is coupled to the internal thread (4b) of the first connection frame (4) by a screw coupling method, a screw (5b) is tightened into the air discharge hole (5a), a connection rod (6), which has a coupling slot (6a) and has an external thread (6b), is coupled to the internal thread (4b′) of the second connection frame (4′) by a screw coupling method, and a plurality of discharge tip assemblies (A), each of which has at opposite ends thereof discharge tip bodies (7) and (7′) connected to each other through a connection pin (8), are fitted over the corrugated grooves of the circumferential outer surface of the stainless steel covering pipe (1) through openings defined in the connection pins (8).

2. The grounding wire structure having the stainless steel covering according to claim 1, wherein only graphite is charged into the stainless steel covering pipe (1) before the corrugated grooves are formed in the circumferential outer surface of the stainless steel covering pipe (1).

3. The grounding wire structure having the stainless steel covering according to claim 1, wherein each discharge tip body (7), (7′) is formed by placing an insulator (10) at a first end in a stainless steel tube (9) and by charging a graphite body (11) at a second end into the stainless steel tube (9), wherein a discharge tip (12) is inserted into the first end of each of the discharge tip bodies (7) and (7′), and a connection pin insert hole (13) is formed in the second end thereof such that the connection pin (8) is coupled to the discharge tip bodies (7) and (7′).

4. The grounding wire structure having the stainless steel covering according to claim 1, wherein, when the discharge tip assemblies (A) are fitted over the stainless covering pipe (1), the discharge tip assemblies (A) are alternately oriented in crossing directions to have cross shapes, thus increasing a discharge area.

5. A method of manufacturing a grounding wire structure having a stainless steel covering, wherein a first end of a stainless steel covering pipe (1) is sealed by a first connection frame (4) and a connection socket (5), a grounding wire (2) is placed in the stainless steel covering pipe (1), graphite (3) is charged into the stainless steel covering pipe (1) at high pressure, the stainless steel covering pipe (1) is heated at 300° C. to 400° C. to remove existing moisture and air, a second end of the stainless steel covering pipe (1) is sealed with a second connection frame (4′) and a connection rod (6) before the heated stainless steel covering pipe (1) is cooled, thus preventing penetration of moisture and air, corrugated grooves, each of which is 2 mm both in width and in depth, are formed in a circumferential outer surface of the stainless steel covering pipe (1), and the discharge tip assemblies (A) are fitted over the corrugated grooves of the stainless steel covering pipe (1) at intervals of 5 cm, wherein each discharge tip assembly (A) is manufactured by inserting a connection pin (8), which is made of a stainless steel wire having a diameter of 2 mm, into connection pin insert holes (13) of discharge tip bodies (7) and (7′), each of which has an outer diameter of 10 mm and a length of 40 mm, and in each of which is manufactured by forming, at a high temperature, an insulator (10), made of heat resistant insulating material, and a graphite body (11), made of graphite and clay, in first and second ends, respectively, of a stainless steel tube (9) in a single process, by inserting a discharge tip (12), which is made of graphite having a melting point of 3000° C. or more and is formed at an end thereof in a needle shape and formed to have a diameter of 0.9 mm or less, into the insulator (10) such that the discharge tip (12) extends from the insulator (10) to a front end of the connection pin insert hole (13) of the graphite body (11), and by heating the discharge tip bodies (7) and (7′) at a high temperature of 1300° C. such that the discharge tip bodies (7) and (7′) are enamelized.

6. The method of manufacturing the grounding wire structure having the stainless steel covering according to claim 5, wherein the first end of the stainless steel covering pipe (1) is sealed by the first connection frame (4) and the connection socket (5), the grounding wire (2) is placed in the stainless steel covering pipe (1), the graphite (3) is charged into the stainless steel covering pipe (1) at high pressure, the stainless steel covering pipe (1) is heated to a temperature ranging from 100° C. to 200° C. to remove existing moisture and air, the second end of the stainless steel covering pipe (1) is sealed using the second connection frame (4′) and the connection rod (6) before the heated stainless steel covering pipe (1) is cooled to prevent penetration of moisture and air, and the corrugated grooves, each of which is 2 mm both in width and in depth, are formed in the circumferential outer surface of the stainless steel covering pipe (1), thus resulting in a grounding wire structure for use in a marshy place.
